(19) United States
(12) Patent Application Publication
(10) Pub. No.: US 2006/0152192 A1
(43) Pub. Date: Jul. 13, 2006

(54) Electronic device and adaptor used therewith

(75) Inventors: Sung-eun Lee, Suwon-si (KR); Byung-Iae Lee, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/319,736

(22) Filed: Dec. 29, 2005

(30) Foreign Application Priority Data
Jan. 12, 2005 (KR) 2005-3000

(51) Int. Cl. H02J 7/00

(52) U.S. Cl. 320/106

(57) ABSTRACT

An electronic device includes a system unit having a plurality of electronic components; a system power supply supplying power to the system unit; a system power controller managing the power supplied from the system power supply to the system unit; and an adaptor including an AC/DC converter converting AC power inputted thereto into DC power corresponding to a selected voltage level amongst a plurality of voltage levels outputted therefrom and outputting the DC power corresponding to the selected voltage level, and an adaptor controller controlling the AC/DC converter to output the DC power corresponding to the selected voltage level amongst the plurality of voltage levels to the system power supply, based on a level selection signal supplied from the system power controller. Thus, the present invention provides an electronic device having an adaptor which can selectively output power according to a level selection signal supplied from the electronic device, and the adaptor used therewith.

### CROSS-REFERENCE TO RELATED APPLICATIONS

This application claims the benefit of Korean Patent Application No. 2005-3000, filed on Jan. 12, 2005 in the Korean Intellectual Property Office, the disclosure of which is incorporated herein by reference.

### BACKGROUND OF THE INVENTION

1. Field of the Invention

An aspect of the present invention relates to an electronic device, and more particularly, to an electronic device having an adaptor which can selectively output a voltage amongst a plurality of voltages according to a level selection signal supplied from the electronic device, and the adaptor used therewith.

2. Description of the Related Art

Recently electronic devices using a battery, such as a laptop computer, a notebook computer, a personal digital assistant (PDA), mobile phones, CD players and video camcorders, etc., are widely used, because they are portable. These electronic devices are provided with an adaptor connection terminal so as to use an adaptor that converts commercial alternating current (AC) power into direct current (DC) power.

The portable electronic devices may also use power from a battery, in addition to the adaptor, enabling the devices to be used without the adaptor being connected to the AC power outlet. On the other hand, when the adaptor is connected to an AC power outlet, the battery can be recharged, making use of power from the adaptor.

As the number of portable electronic devices increases, technologies associated with extending battery duration, such as power saving, have become more significant. Accordingly, various technologies have been proposed so as to reduce power consumption of the portable electronic devices to a minimum, and to switch the devices to a power saving mode when preset conditions are met, while these electronic devices are using power outputted from the battery.

However, when an electronic device is supplied with power from an adaptor, no consideration is made as to power saving. Accordingly, the adaptor used with the electronic device is provided so as to output DC power of the highest voltage level among the voltage levels required for driving the electronic device. This would cause unnecessary loss of power in those electronic devices that drop the power outputted from the adaptor to a certain degree.

In addition, since the voltage level of the power outputted by the adaptor may vary depending upon the kind of the electronic device used with the concerned adaptor, it is actually difficult to use the adaptor in various electronic devices.

Further, there is likelihood that an ordinary user having insufficient knowledge of electronic devices or adaptors uses an incorrect adaptor on an electronic device, e.g., an adaptor for a portable computer on a monitor, which may damage the electronic device.

### SUMMARY OF THE INVENTION

Accordingly, it is an aspect of the present invention to provide an electronic device having an adaptor which can selectively output power corresponding to plural voltage levels according to a level selection signal supplied from the electronic device, and the adaptor used therewith.

Additional aspects and/or advantages of the invention will be set forth in part in the description which follows and, in part, will be obvious from the description, or may be learned by practice of the invention.

The foregoing and/or other aspects of the present invention are achieved by providing an electronic device including a system unit having a plurality of electronic components, including a system power supply supplying power to the system unit; a system power controller managing the power supplied from the system power supply to the system unit; and an adaptor including an AC/DC converter converting AC power inputted thereto into DC power corresponding to a level of plural voltage levels possibly outputted therefrom and outputting the DC power, and an adaptor controller controlling the AC/DC converter to output the DC power corresponding to a level of the plural voltage levels to the system power supply, based on a predetermined level selection signal supplied from the system power controller.

According to another aspect of the present invention, the system power controller and the adaptor controller are interconnected through an I2C communication protocol.

According to an aspect of the present invention, the adaptor controller provides information regarding the voltage levels that can be outputted by the AC/DC converter to the system power controller; and the system power controller outputs the level selection signal to select the DC power corresponding to one level of the voltage levels that can be outputted by the AC/DC converter, based on information regarding the voltage level supplied from the adaptor controller.

According to an aspect of the present invention, the electronic device further includes a battery supplying a battery power to the system power supply, and a battery charger charging the battery, making use of the DC power outputted from the AC/DC converter, wherein the system power controller outputs the level selection signal to the adaptor controller, corresponding to whether the system unit is in operation and/or the battery charger is charging the battery.

The foregoing and/or other aspects of the present invention are achieved by providing an adaptor converting AC power into DC power and outputting the DC power to an electronic device. The adaptor includes an AC/DC converter converting the AC power into the DC power corresponding to a level of plural voltage levels possibly outputted therefrom and outputting the DC power; and an adaptor controller controlling the AC/DC converter to output the DC power corresponding to a level among the plural voltage levels to the electronic device, based on a predetermined level selection signal supplied from the electronic device.

According to an aspect of the present invention, the adaptor controller receives the level selection signal from the electronic device through an I2C communication protocol.

According to an aspect of the present invention, the adaptor controller supplies information regarding the voltage levels that can be outputted by the AC/DC converter to the electronic device through the I2C communication protocol.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following description of the embodiments, taken in conjunction with the accompany drawings of which:

FIG. 1 is a control block diagram of an electronic device according to an embodiment of the present invention;

FIGS. 2 and 3 are control block diagrams illustrating various embodiments of an adaptor of FIG. 1; and

FIG. 4 is a control block diagram of an electronic device according to another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

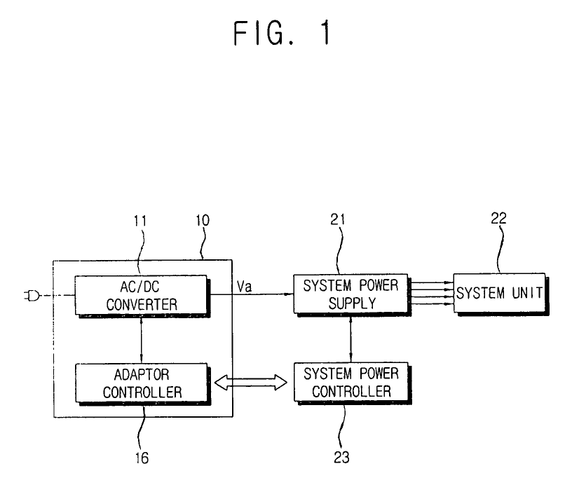

As illustrated in FIG. 1, an electronic device according to an embodiment of the present invention includes a system unit 22, a system power supply 21, a system power controller 23, and an adaptor 10.

The system unit 22 includes a variety of electronic components to perform main functions of the electronic device when power is supplied thereto from the system power supply 21. For example, when the electronic device according to an aspect of the present invention is a portable computer, electronic components of the system unit 22 would include a central processing unit (CPU), a memory such as read access memory (RAM), a chipset, a main board, and a graphic card, etc.

The system power supply 21 converts direct current (DC) power Va supplied from the adaptor 10 into power of the voltage level required for driving each electronic component and outputs the converted power. The system power supply 21 may include a plurality of voltage regulators to respectively generate powers of voltage levels adaptive to the specifications thereof. For example, where the electronic device according to an aspect of the present invention is a portable computer, respective voltage regulators of the system power supply 21 output powers at various voltage levels required for driving each electronic component, for example, ±12V, ±5V, ±3.3V, ±2.5V, etc., and powers of the various voltage levels outputted from each voltage regulator are used as powers necessary for driving and/or transmitting signals as required by each electronic component.

The system power controller 23 manages power supplied to the system unit 22 from the system power supply 21. The system power supply 21 according to an aspect of the present invention outputs a level selection signal to an adaptor controller 16. Both of which will be described later.

The adaptor 10 is supplied with commercial AC power, converts the inputted commercial AC power into the DC power Va of a predetermined voltage level, and outputs the DC power Va to the system power supply 21. The adaptor 10 according to an aspect of the present invention may selectively output the DC power Va corresponding to a certain level of plural voltage levels.

The adaptor 10 according to one embodiment of the present invention may include an AC/DC converter 11 and the adaptor controller 16.

The AC/DC converter 11 converts the inputted AC power into the DC power Va and outputs the DC power Va. The AC/DC converter 11 can selectively convert the inputted AC power into the DC power Va corresponding to a certain level of the plural voltage levels, according to a signal by the adaptor controller 16 and outputs the DC power Va. The DC power Va outputted from the AC/DC converter 11 is outputted to the system power supply 21, and the system power supply 21 converts the DC power Va supplied from the AC/DC converter 11 into powers of various voltage levels, as described above.

The adaptor controller 16 controls the AC/DC converter 11 to output the DC power Va corresponding to one level of the plural voltage levels, based on the level selection signal supplied from the system power supply 21.

The adaptor controller 16 is interconnected with the system power supply 21 through a communication protocol available for bi-directional communications. In an embodiment of the present invention, connection of the adaptor controller 16 with the system power supply 21 through the I2C communication protocol is merely by way of example. Once the adaptor controller 16 and the system power supply 21 are available for bi-directional communication, they can be connected through different communication protocols.

The adaptor controller 16 may provide the system power controller 23 with information about the voltage level that the AC/DC converter 11 can output. The system power supply 21 may output a level selection signal to select the DC power Va corresponding to some level, of the voltage levels that the AC/DC converter 11 can output, based on the information about the voltage level supplied from the adaptor controller 16. According to this information, the system power supply 21 can be supplied with the voltage level which can be outputted by the adaptor 10, and can output the level selection signal to the adaptor 10 to receive the voltage level that the system power supply 21 needs.

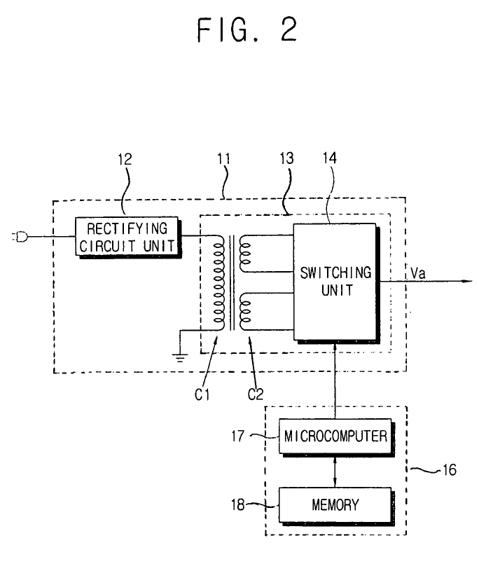

FIG. 2 illustrates an example of an adaptor 10 of the electronic device according to an embodiment of the present invention. As illustrated therein, the AC/DC converter 11 of the adaptor 10 includes a rectifying circuit unit 12 rectifying AC power, and a transformation unit 13 transforming the DC power supplied from the rectifying circuit unit 12 into DC power Va of some voltage level among the plurality of voltage levels.

The transformation unit 13 includes a switching unit 14 to switch a winding ratio between a primary winding C1 and a secondary winding C2 according to a control signal from the adaptor controller 16. That is, the voltage level of the DC power Va outputted from the transformation unit 13 is determined depending upon the winding ratio between the primary winding C1 and the secondary winding C2 as a result of a switching operation of the switching unit 14. Accordingly, the adaptor controller 16 can change the voltage level of the DC power Va outputted from the adaptor 10, by changing the winding ratio between the primary winding C1 and the secondary winding C2 through the control by the switching unit 14.

The adaptor controller 16 may, as illustrated in FIG. 2, include a memory such as EEPROM, storing therein information about the level selection signal supplied from the system power controller 23, and a microcomputer 17 controlling the switching unit 14 according to the information regarding the level selection signal stored in the memory 18.

The system power supply 21 may supply the level selection signal to the adaptor controller 16 through a method of accessing a special address of the memory 18 of the adaptor controller 16 through the I2C communication line described above and changing the content of the concerned address. At this time, the microcomputer 17 can control the switching unit 14 of the AC/DC converter 11 based on the content recorded on the concerned address.

For example, where an adaptor 10 outputs powers of two voltage levels, the system power supply 21 changes the special address of the memory 18 of the adaptor controller 16 to ‘0’ or ‘1,’ and the microcomputer 17 can control the switching unit 14 so that either of the voltage levels can be selectively outputted based on the address value of the memory 18.

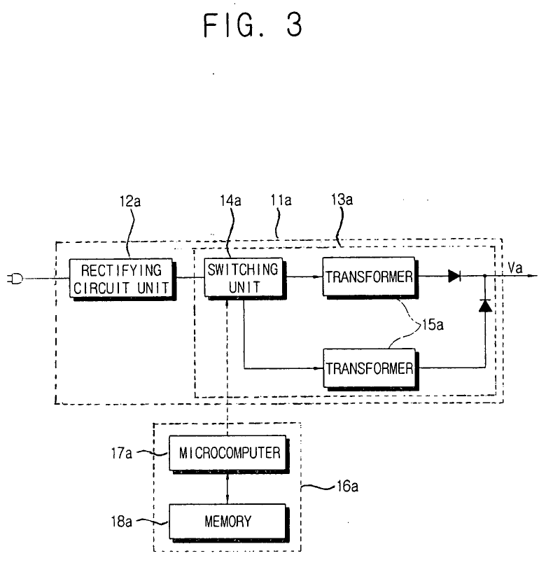

FIG. 3 illustrates another example of the adaptor of the electronic device according to an embodiment of the present invention. As illustrated, an AC/DC converter 11a of the adaptor 10 includes a rectifying circuit unit 12a rectifying AC power, and a transformation unit 13a transforming the DC power supplied from the rectifying circuit unit 12a into DC power Va corresponding to one level of the plural voltage levels.

The transformation unit 13a may include a plurality of transformers 15a to output DC powers Va of different voltage levels, and a switching unit 14a supplying the DC power outputted from the rectifying circuit unit 12a selectively to one of the transformers 15a. Accordingly, the adaptor controller 16a allows the DC power outputted from the rectifying circuit unit 12a through control by the switching unit 14a to be selectively supplied to one of the plural transformers 15a, thereby enabling the DC power Va of a voltage level among the plural voltage levels to be outputted to the adaptor 10.

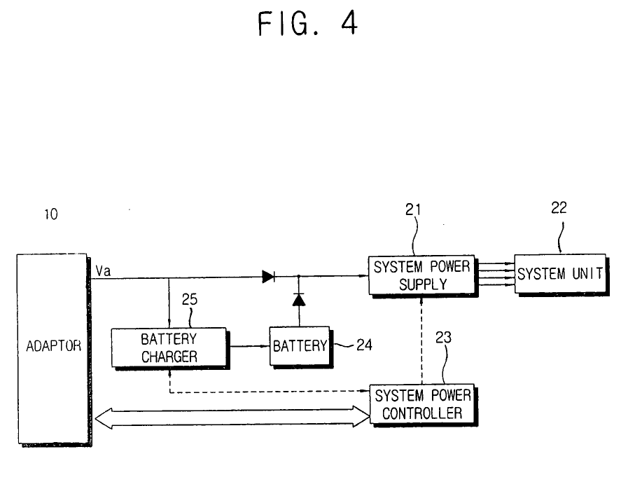

Hereinbelow, the electronic device according to another embodiment of the present invention will be described with reference to FIG. 4. Here, the electronic device according to this embodiment can employ the functions of the electronic device of the one embodiment described above. For example, the adaptor according to this embodiment may correspond in configuration to the adaptor 10 according to the one embodiment described above.

The electronic device according to this embodiment includes an adaptor 10, a system power supply 21, a system unit 22, a system power controller 23, a battery 24, and a battery charger 25. The adaptor 10, the system power supply 21, and the system unit 22 correspond to those of the electronic device according to the above-described embodiment. Thus, a description thereof will be omitted.

The battery 24 is a second battery which can be recharged by the battery charger 25, for example, a lithium-ion battery. The battery 24 is constructed with at least one or more battery cells, each having its own specification regarding recharge and discharge voltages. For example, where the battery 24 is constructed with 3 battery cells (3 Series) that each battery cell has 4.2V of the voltage level required for charging the battery and 3.7V of the maximum discharge voltage level, the voltage level of power required for charging the battery 24 is 12.6V and the maximum voltage level of power outputted from the battery 24 is 11.1V.

The battery charger 25 charges the battery 24 with DC power Va supplied from the adaptor 10. Here, the battery charger 25 converts the DC power Va supplied from the adaptor 10 into power of a voltage level required for charging the battery 24, for example, 12.6V, to charge the battery 24.

Where power of the system unit 22 is OFF, the system power controller 23 controls the battery charger 25 so that the battery 24 is charged with the DC power Va outputted from the adaptor 10.

The system power controller 23 can control the battery charger 25 so as to charge the battery 24 while the system unit 22 is driving. That is, the system power controller 23 controls the battery charger 25 so as to charge the battery 24, making use of the remainder of the power used by the system power supply 21, within the DC power Va outputted from the adaptor 10, while the system unit 22 is at the ON state.

The system power controller 23 can output a level selection signal to the adaptor controller 16, corresponding to whether the system power 22 is in operation and/or the battery charger 25 is charging the battery 24. That is, the system power controller 23 can output respective level selection signals to the adaptor controller 16, corresponding to a case where only the system unit 22 is operated, a case where only the battery 24 is charged while the system unit is not in operation, and a case where the battery 24 is charged while the system unit 22 is in operation.

For example, where the battery 24 is charged while the system unit 22 is in operation, the system power controller 23 may output a level selection signal to the adaptor controller 16 so that the DC power Va having the voltage level higher than the other cases can be supplied from the adaptor 10.

As described above, according to the present invention there is provided an electronic device having an adaptor available for selectively outputting each power corresponding to plural voltage levels according to a level selection signal supplied from the electronic device and the adaptor used therewith.

Although the present invention has been described in connection with the embodiments illustrated in the accompanying drawings, it should be understood that the present invention is not limited thereto and those skilled in the art can make various modifications and changes without departing from the scope of the invention.

What is claimed is:

1. An electronic device comprising:
a system unit having a plurality of electronic components;
a system power supply supplying power to the system unit;
a system power controller managing the power supplied from the system power supply to the system unit; and
an adaptor comprising an AC/DC converter converting AC power inputted thereto into DC power corresponding to a selected voltage level amongst a plurality of voltage levels outputted therefrom and outputting the DC power corresponding to the selected voltage level, and an adaptor controller controlling the AC/DC converter to output the DC power corresponding to the selected voltage level amongst the plurality of voltage levels to the system power supply, based on a level selection signal supplied from the system power controller.

2. The electronic device according to claim 1, wherein the system power controller and the adaptor controller are interconnected through an I2C communication protocol.

3. The electronic device according to claim 2, wherein the adaptor controller provides information regarding the plurality of voltage levels outputted by the AC/DC converter to the system power controller; and
the system power controller outputs the level selection signal to select the DC power corresponding to the selected voltage level amongst the plurality of voltage levels outputted by the AC/DC converter, based on information regarding the plurality of voltage levels supplied from the adaptor controller.

4. The electronic device according to claim 3, further comprising a battery supplying a battery power to the system power supply, and a battery charger charging the battery, making use of the DC power outputted from the AC/DC converter,
wherein the system power controller outputs the level selection signal to the adaptor controller, corresponding to whether the system unit is in operation and/or the battery charger is charging the battery.

5. The electronic device according to claim 1, wherein the system power supply comprises a plurality of voltage regulators to generate the plurality voltage levels according to specifications of the system unit and the level selection signal.

6. The electronic device according to claim 1, wherein the system power controller and the adaptor controller are interconnected through a communication protocol for bi-directional communications.

7. An adaptor converting AC power into DC power and outputting the DC power to an electronic device, comprising:
an AC/DC converter converting the AC power into the DC power corresponding to a voltage level amongst a plurality of voltage levels outputted therefrom and outputting the DC power; and
an adaptor controller controlling the AC/DC converter to output the DC power corresponding to the voltage level amongst the plurality of voltage levels to the electronic device, based on a level selection signal supplied from the electronic device.

8. The adaptor according to claim 7, wherein the adaptor controller receives the level selection signal from the electronic device through an I2C communication protocol.

9. The adaptor according to claim 8, wherein the adaptor controller supplies information regarding the plurality of voltage levels outputted by the AC/DC converter to the electronic device through the I2C communication protocol.

10. The adaptor according to claim 7, wherein the AC/DC converter comprises a rectifying circuit unit rectifying the AC power, and a transformation unit transforming the DC power supplied from the rectifying circuit unit into the DC power corresponding to the level selection signal supplied from the electronic device.

11. The adaptor according to claim 10, wherein the transformation unit includes a switching unit to switch a winding ratio between a primary winding and a secondary winding according to a control signal from the adaptor controller.

12. The adaptor according to claim 11, wherein the adaptor controller changes the voltage level of the DC power outputted from the adaptor, by changing the winding ratio between the primary winding and the secondary winding.

13. The adaptor according to claim 7, wherein the adaptor controller includes a memory storing information about the level selection signal supplied from the system power controller, and a microcomputer controlling the switching unit according to the information regarding the level selection signal stored in the memory.

14. The adaptor according to claim 7, wherein the AC/DC converter comprises a rectifying circuit unit rectifying the AC power, and a transformation unit transforming the DC power supplied from the rectifying circuit unit into DC power corresponding to the level selection signal.

15. The adaptor according to claim 14, wherein the transformation unit includes a plurality of transformers to output the DC powers of different voltage levels, and a switching unit supplying the DC power outputted from the rectifying circuit unit selectively to one of the plurality of transformers.

16. The adaptor according to claim 15, wherein the adaptor controller allows the DC power outputted from the rectifying circuit unit through control by the switching unit to be selectively supplied to one of the plurality of transformers, enabling the DC power of a voltage level amongst the plurality of voltage levels to be outputted by the adaptor.

17. An electronic device comprising:
a system unit having a plurality of electronic components;
a system power supply supplying power to the system unit;
a system power controller managing the power supplied from the system power supply to the system unit; and
an adaptor converting input AC power into DC power according to a level selection signal supplied from the system power controller and outputting the DC power to the system power supply.

18. The electronic device according to claim 17, wherein the adaptor comprises an AC/DC converter converting the AC power inputted thereto into the DC power corresponding to the level selection signal, and an adaptor controller controlling the AC/DC converter to output the DC power corresponding to the level selection signal to the system power supply.

19. The electronic device according to claim 18, further comprising a battery supplying a battery power to the system power supply, and a battery charger charging the battery, making use of the DC power outputted from the AC/DC converter,
wherein the system power controller outputs the level selection signal to the adaptor controller, depending upon whether the system unit is in operation and/or the battery charger is charging the battery.

20. The electronic device according to claim 18, wherein the system power controller and the adaptor controller are interconnected through an I2C communication protocol.

21. The electronic device according to claim 17, wherein the system power supply comprises a plurality of voltage regulators to generate different voltage levels according to specifications of the system unit and the level selection signal.
